(19) United States
(12) Patent Application Publication
(10) Pub. No.: US 2015/0039592 A1
(43) Pub. Date: Feb. 5, 2015

(54) Apparatus and Method for Automatically Creating a Multimedia Presentation from Evaluated Content

(71) Applicant: Haiku Deck, Inc., Seattle, WA (US)

(72) Inventor: Kevin Leneway, Seattle, WA (US)

(73) Assignee: Haiku Deck, Inc., Seattle, WA (US)

(21) Appl. No.: 14/447,229

(22) Filed: Jul. 30, 2014

Related U.S. Application Data
(60) Provisional application No. 61/860,205, filed on Jul. 30, 2013.

(51) Int. Cl. G06F 17/30; G06F 17/21

(52) U.S. Cl. CPC G06F 17/30268; G06F 17/211
USPC 707/722; 715/202

(57) ABSTRACT

A method executed by a processor under the control of instructions includes ingesting content including textual content and numeric content. Concepts associated with the textual content are mapped to images. Visualizations corresponding to the numeric content are created. A presentation of the content that includes the images and visualizations is supplied.

### CROSS-REFERENCE TO RELATED APPLICATION

This application claims prior to U.S. Provisional Patent Application Ser. No. 61/860,205, filed Jul. 30, 2013, the contents of which are incorporated herein by reference.

### FIELD OF THE INVENTION

This invention relates generally to data processing. More particularly, this invention relates to creating a multimedia presentation from evaluated content.

### BACKGROUND OF THE INVENTION

The effectiveness of information conveyed to an individual tends to be enhanced if there is a visual component to the information. A great deal of information, such as an outline, a blog post, a report and the like, is initially in a text-only form.

Therefore, there is a need for automatically creating multimedia content from textual information.

### SUMMARY OF THE INVENTION

A method executed by a processor under the control of instructions includes ingesting content including textual content and numeric content. Concepts associated with the textual content are mapped to images. Visualizations corresponding to the numeric content are created. A presentation of the content that includes the images and visualizations is supplied.

A server includes a processor and a memory storing data and instructions executed by the processor. The memory includes a consumption module to ingest content including textual content and numeric content. An image search module identifies images and associated tags. The image search module receives keywords from the consumption module and matches the keywords to selected tags to establish selected images. A visualization module receives numeric content from the consumption module and supplies visualizations corresponding to the numeric content. A visual presentation module supplies a presentation of the content that includes the images and visualizations.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates a user interface to facilitate the consumption of textual information.

FIG. 4 illustrates a presentation processed in accordance with an embodiment of the invention.

FIG. 5 illustrates image content supplied in accordance with an embodiment of the invention.

FIGS. 6 and 7 illustrate data visualizations supplied in accordance with an embodiment of the invention.

FIG. 8 illustrates image content supplied in accordance with an embodiment of the invention.

FIG. 9 illustrates an interface to facilitate the consumption of web content.

FIG. 10 illustrates exemplary web content processed in accordance with an embodiment of the invention.

FIGS. 11-15 illustrate image content corresponding to the web content of FIG. 10, as supplied in accordance with an embodiment of the invention.

Like reference numerals refer to corresponding parts throughout the several views of the drawings.

### DETAILED DESCRIPTION OF THE INVENTION

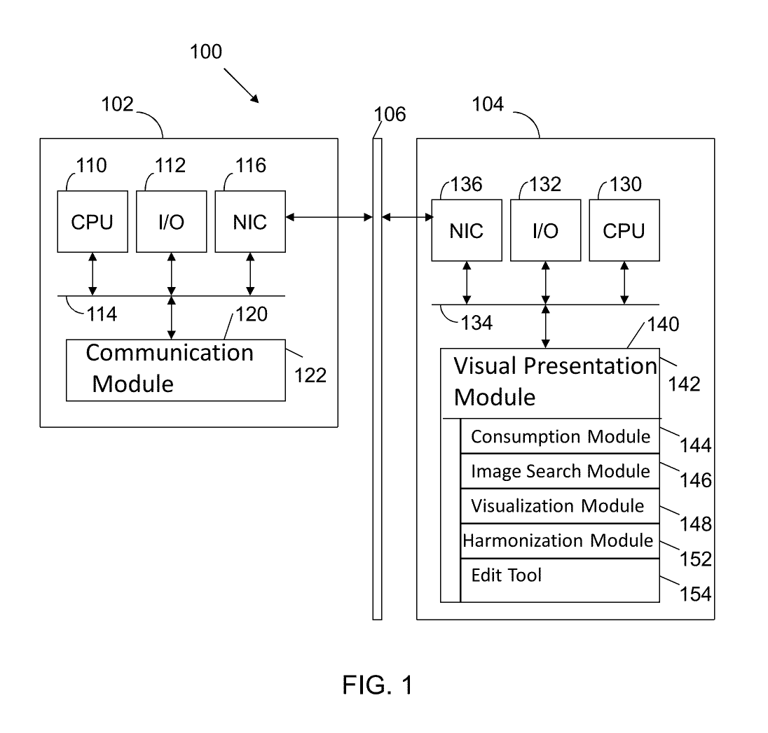

FIG. 1 illustrates a system 100 configured in accordance with an embodiment of the invention. The system 100 includes a client device 102 and a server 104 connected via a network 106, which may be any combination of wired and wireless networks. The client device 102 may be a desktop computer, laptop computer, tablet, smartphone, wearable device and the like. The client 102 includes standard components, such as a central processing unit 110 and input/output devices 112 connected via a bus 114. The input/output devices 112 may include a keyboard, mouse, touch display, monitor and the like. A network interface circuit 116 is also connected to the bus 114 to provide connectivity to network 106. A memory 120 is also connected to the bus 114. The memory 120 stores a communication module 122, which may be a standard web browser or a dedicated application for communication with server 104.

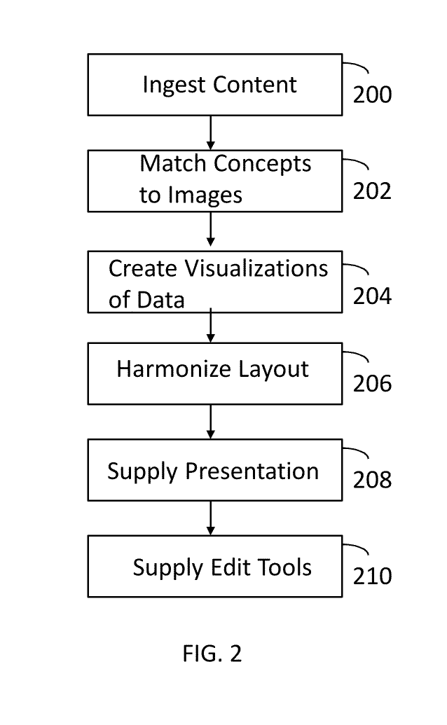

Server 104 also includes standard components, such as a central processing unit 130, input/output devices 132, a bus 134 and a network interface circuit 136. A memory 140 is also connected to the bus 134. The memory 140 stores instructions executed by the central processing unit 130 to implement operations of the invention. In one embodiment, the memory 140 stores a visual presentation module 142, which implements operations of the type discussed in connection with FIG. 2. The visual presentation module 142 may have an associated consumption module 144, with instructions to supply prompts to a user and to consume textual information specified by a user, as demonstrated below. The visual presentation module 142 may also include an image search module 146. The image search module 146 has a set of images (i.e., static content, animated content, video content and the like) and/or is configured to identify such images across network 106. Each image has associated tags that characterize the nature of the content. Each image may have associated audio. The image search module 146 may store a pre-selected set of images and tags. The image search module may also be configured to search the web for images and associated tags.

The visual presentation module 142 may also include a visualization module 148. The visualization module 148 includes instructions to generate visualizations of data consumed by the consumption module 144. The visual presentation module 142 may also utilize a harmonization module 152. The harmonization module has instructions to choose and/or harmonize color between images, visualizations and text. The harmonization module 152 may also optimize themes, capitalization scheme and layout. The visual presentation module 142 may also utilize an edit tool 154. The edit tool 154 provides a user with prompts that allow a user to modify content created by the visual presentation module 142.

The configuration of system 100 is exemplary. It should be appreciated that the modules of the visual presentation module 142 may be combined or distributed across multiple machines. Indeed, the visual presentation module 142 may be executed across a number of machines connected via the network 106. It is the operations of the invention that are noteworthy, not the particular nature of implementing those operations.

FIG. 2 illustrates processing operations associated with an embodiment of the visual presentation module 142. Initially, content is ingested 200. As demonstrated below, the consumption module 142 may supply prompts to a user of a client device 102 to specify content to be consumed by the visual presentation module 142.

Next, concepts within the content are matched with images 202. In one embodiment, the consumption module 144 parses the content to identify salient concepts. The consumption module 144 then makes calls to the image search module 146 for images that correlate with tags, specified keywords, associated keywords or synonyms thereof The image search module 146 performs lookups of tags associated with images on network 106 and supplies a highly ranked result. The rank of the result may be based on a variety of weighted criteria, such as keyword match, popularity of image, relevance to other concepts in the consumed content and the like.

The next operation of FIG. 2 is to create visualizations for data 204. In one embodiment, the consumption module 144 parses numeric values and delivers them to the visualization module 148. The visualization module 148 evaluates the numeric values and selects appropriate visualizations for the content. Visualization selection may be based upon pre-existing rules that specify appropriate visualizations for certain types of numeric values. For example, the pre-existing rules may specify appropriate visualizations based upon data volume, data type, and the like. The visualizations may include graphs, pie charts, scatter plots and the like.

Based upon images selected and visualizations created, the layout may be harmonized 206. For example, the harmonization module 152 may evaluate selected images and generated visualizations and modify the color associated with generated text and visualizations to create a harmonized color palette across images, visualizations and text. Alternately or in addition, the harmonization module 152 select themes, capitalization schema and layout parameters

At this point, a multimedia presentation corresponding to the originally consumed text may be supplied 208. Examples of such content are provided below. Finally, the visual presentation module 142 may supply edit tools 210. For example, the edit tool 154 may allow a user to modify the originally supplied multimedia presentation, as demonstrated below.

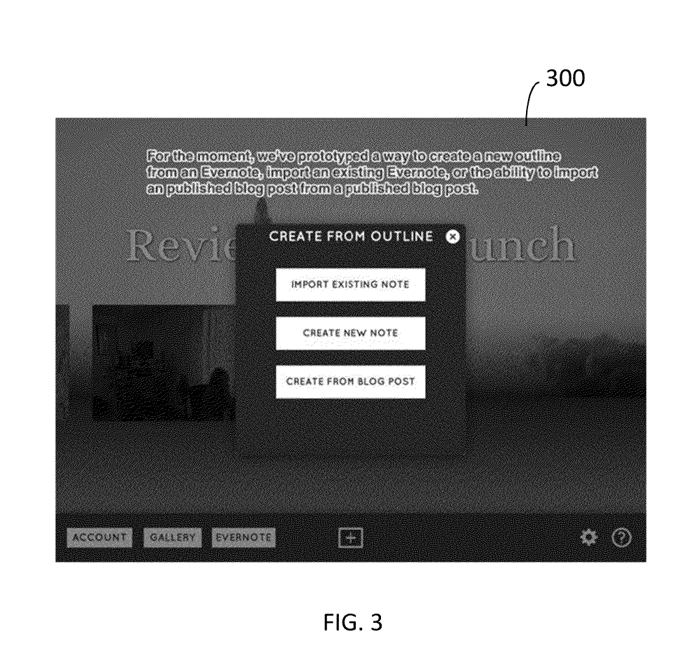

FIG. 3 illustrates a user interface 300 that may be supplied in accordance with an embodiment of the invention. The consumption module 144 may supply the user interface 300. In this example, the user interface 300 allows one to import an existing note, a new note or a blog post. The note may be a note formatted in accordance with the Evernote® application from Evernote Corporation, Redwood City, Calif. Naturally, other interfaces may be used to specify other types of textual files, such as documents generated by a word processor, an email, a web page, a blog post and the like.

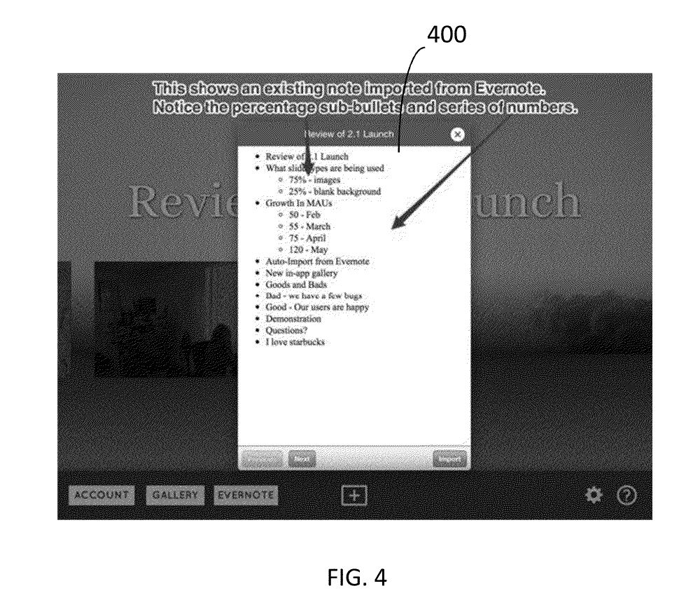

FIG. 4 illustrates a note 400 consumed in accordance with an embodiment of the invention. In this example, the note 400 includes references to “Review of 2.1 Launch”, percentage values, a series of numeric entries and a reference to Evernote®.

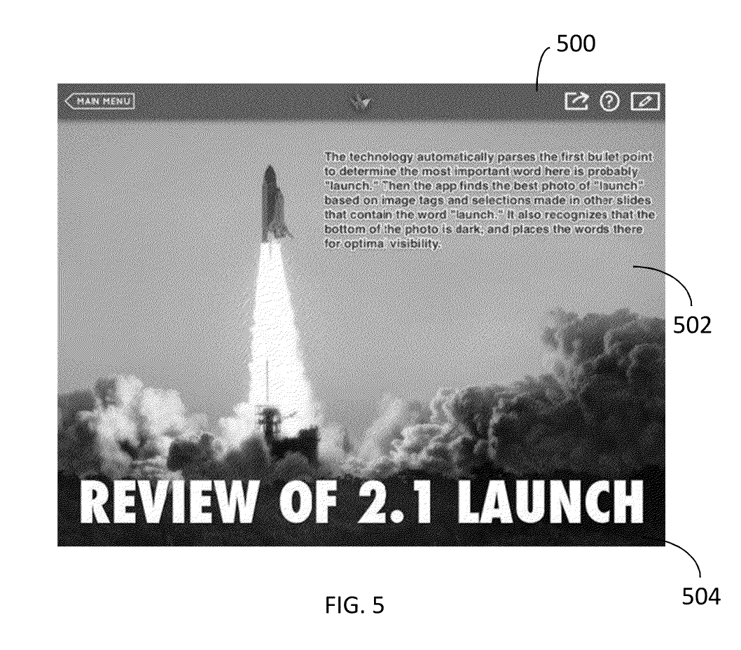

FIG. 5 illustrates a first page 500 associated with a generated multimedia presentation. The first page 500 includes a rocket launch image 502 and the text “Review of 2.1 Launch” 504 from the original consumed content. In this case, the consumption module 144 deduces that the concept of “Launch” is more important than “Review” and therefore passes the “Launch” keyword to the image search module 146. The image search module 146 selects an image based upon image tags and weighted value based upon selections made in other slides that contain the word “Launch”. The image search module 146 also observes that the bottom of the photo is dark and therefore places words there for optimal visibility. The harmonization module 152 chooses a light color font for maximum contrast with the dark portion of the image.

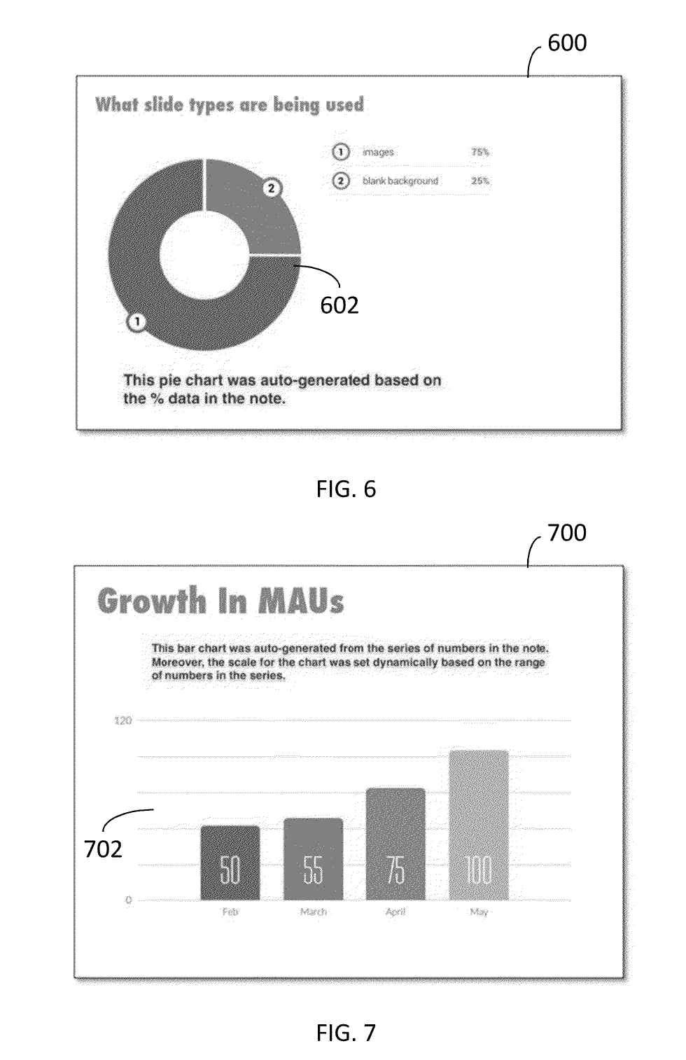

FIG. 6 illustrates a second page 600 associated with a generated multimedia presentation. The second page 600 has an associated pie chart 602, which provides a visualization of the percentages specified in the originally consumed content.

FIG. 7 illustrates a third page 700 associated with a generated multimedia presentation. The third page 700 has a bar graph 702, which provides a visualization of the numeric values specified in the originally consumed content.

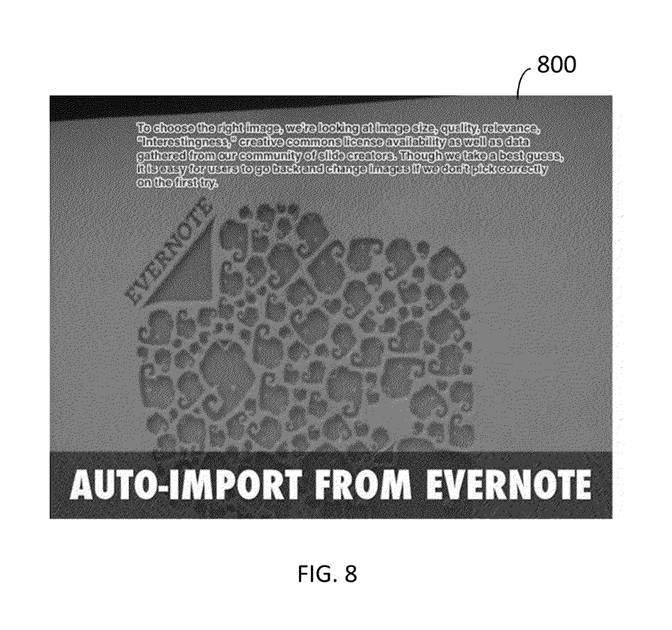

FIG. 8 illustrates a fourth page 800 associated with a generated multimedia presentation. The image here corresponds to an image associated with the Evernote® application, which is specified in the originally consumed content. The selection may be based on image size, quality, relevance, Creative Commons license availability, and/or weighted data obtained from previous use scenarios.

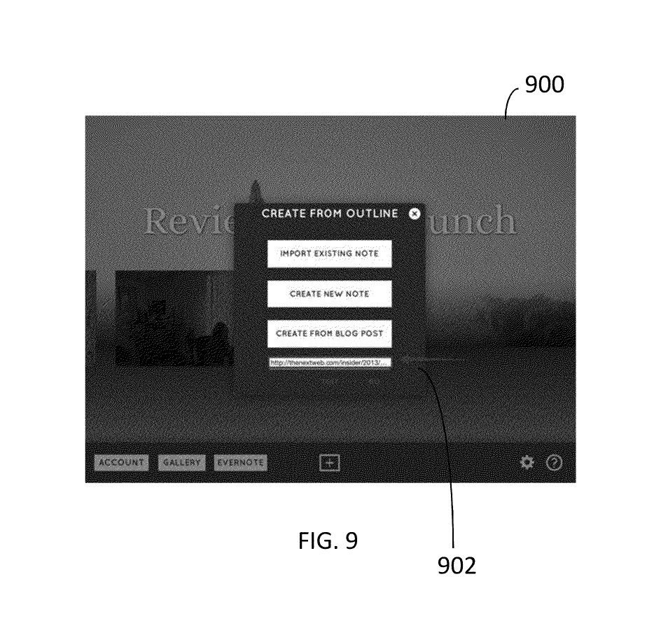

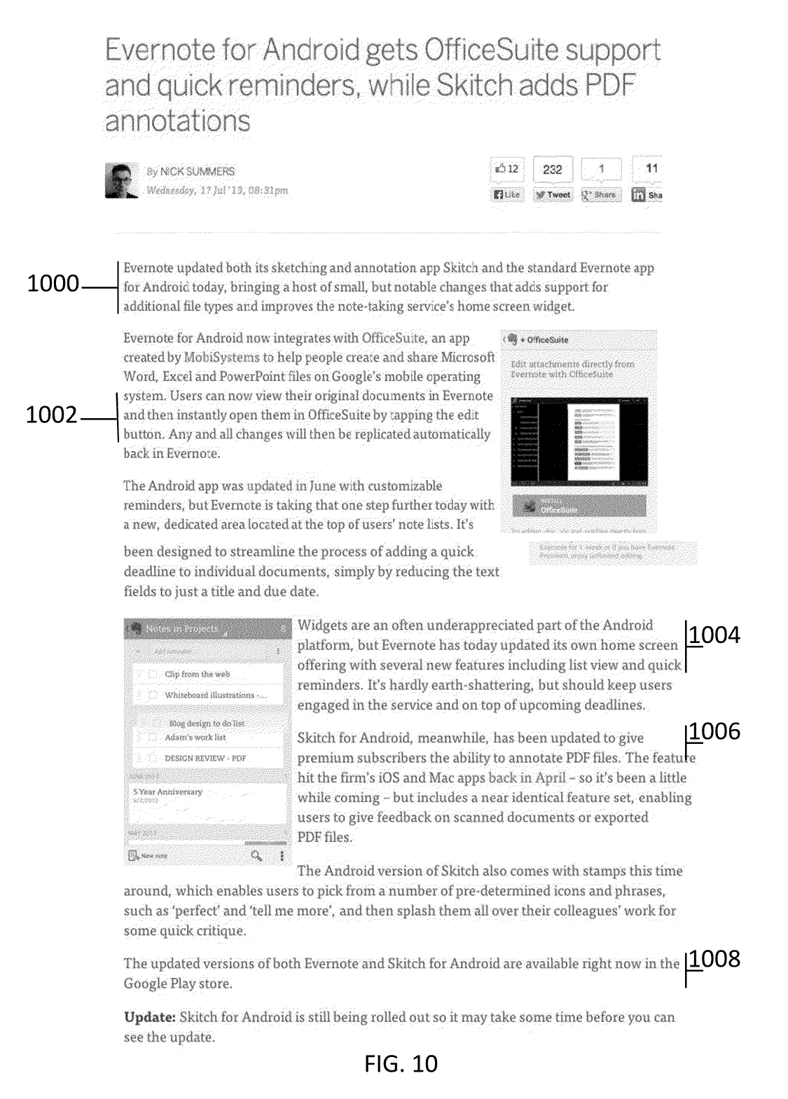

FIG. 9 illustrates a user interface 900, which allows one to specify a web address 902 for content to be consumed in accordance with an embodiment of the invention. FIG. 10 illustrates an example of a blog post associated with the specified web address. The consumption module 144 processes this content and selectively reduces its volume by approximately one-half Text snippets 1000, 1002, 1004, 1006 and 1008 appear in the generated pages presented below.

The consumption module 144 annotates images with key sentences from the post. Images are selected by passing keywords that are deemed most representative of concepts in the text snippets.

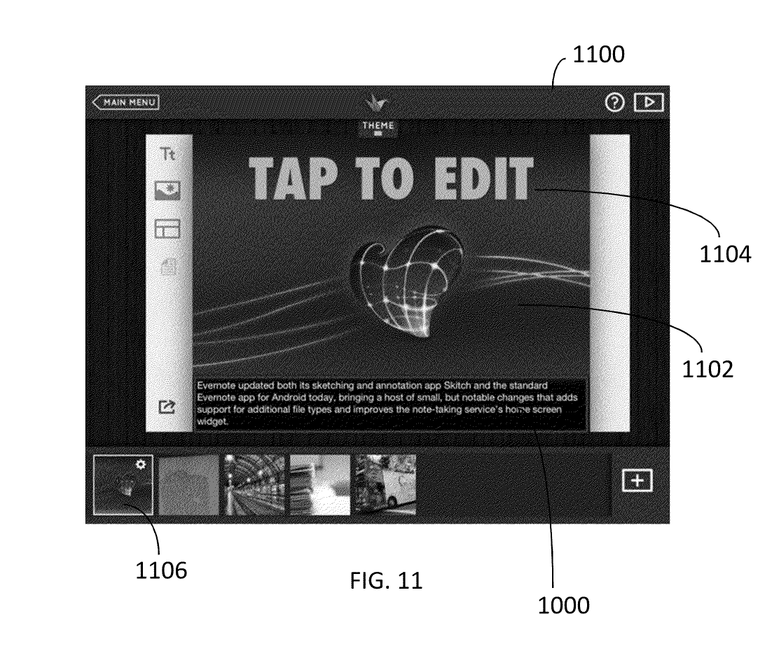

FIG. 11 illustrates a first page 1100 with text snippet 1000. The first page 1100 includes an image 1102 deemed relevant to the text snippet 1000. That is, the consumption module 144 working with the image search module 146 selects image 1102. A “Tap to Edit” prompt 1104 may be used to invoke the edit tool 154. Also observe that a preview bar 1106 shows all slides associated with the generated multimedia presentation.

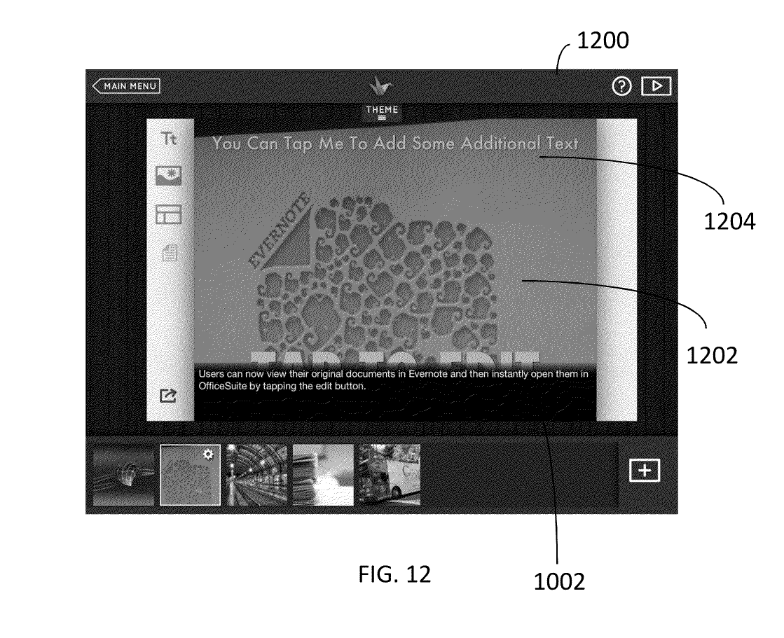

FIG. 12 illustrates a second page 1200 with text snippet 1002. The second page 1200 includes an image 1202 deemed relevant to the text snippet 1004. Once again, an edit prompt 1204 is provided.

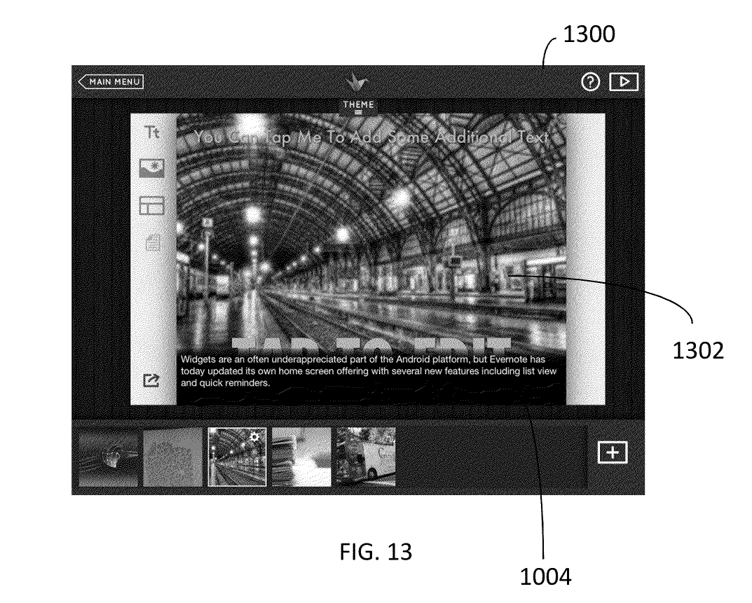

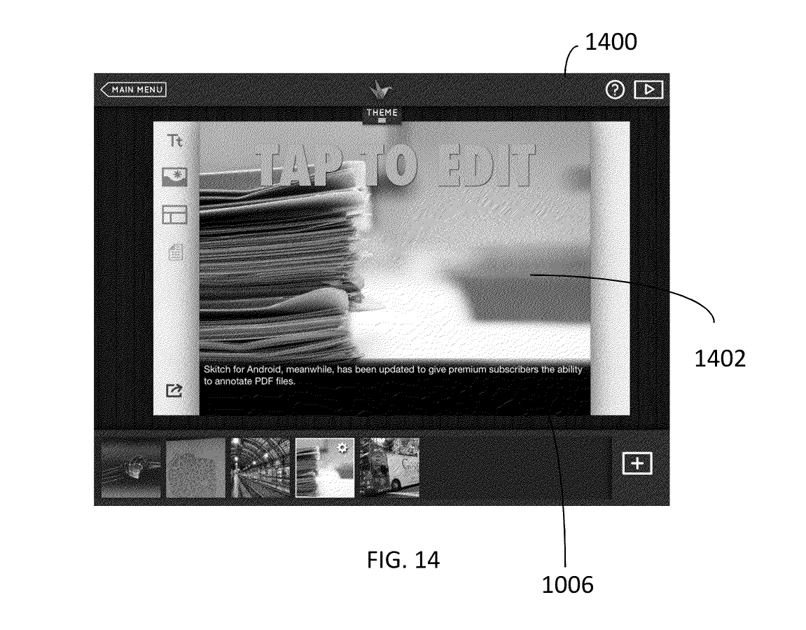

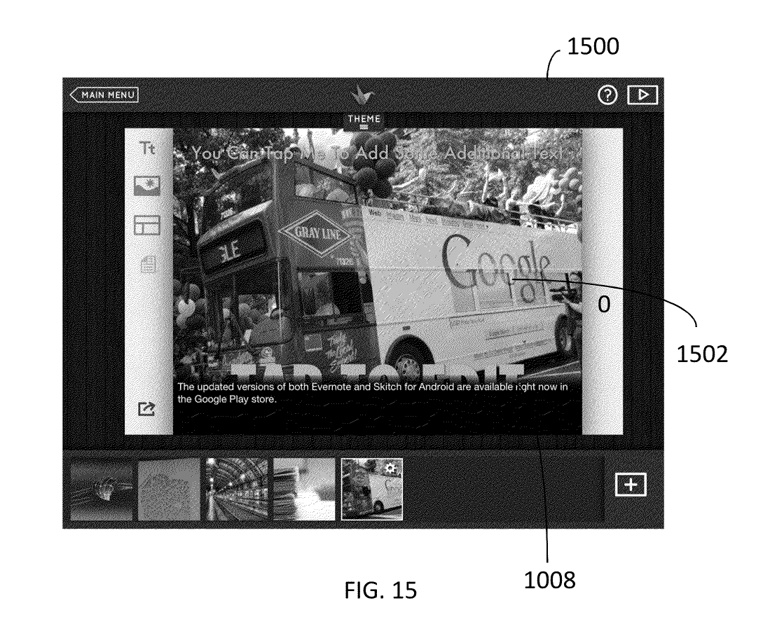

FIG. 13 illustrates a third page 1300 with text snippet 1004. The third page 1300 includes an image 1302 deemed relevant to the text snippet 1004. Similarly, FIG. 14 illustrates a fourth page 1400 with text snippet 1006. The fourth page 1400 includes an image 1402 deemed relevant to the text snippet 1006. Finally, FIG. 15 illustrates a fifth page 1500 with text snippet 1008. The fifth page 1500 includes an image 1502 deemed relevant to the text snippet 1008.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using the JAVA® programming language, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

In the claims:

1. A method executed by a processor under the control of instructions, comprising:
ingesting content including textual content and numeric content;
matching concepts associated with the textual content to images;
creating visualizations corresponding to the numeric content; and
supplying a presentation of the content that includes the images and visualizations.

2. The method of claim 1 further comprising harmonizing presentation attributes.

3. The method of claim 2 wherein the presentation attributes include colors, themes, capitalization and layout.

4. The method of claim 1 further comprising supplying an edit tool to facilitate modification of the presentation.

5. The method of claim 1 wherein the images are selected from static content, animated content and video content.

6. The method of claim 1 wherein the images have associated audio.

7. The method of claim 1 wherein the visualizations are selected from graphs, pie charts and scatter plots.

8. A server, comprising:
a processor; and
a memory storing data and instructions executed by the processor, wherein the memory includes:
a consumption module to ingest content including textual content and numeric content,
an image search module to identify images and associated tags, wherein the image search module receives keywords from the consumption module and matches the keywords to selected tags to establish selected images,
a visualization module to receive numeric content from the consumption module and supply visualizations corresponding to the numeric content,
a visual presentation module to supply a presentation of the content that includes the images and visualizations.

9. The server of claim 8 wherein the consumption module supplies a user interface with prompts to specify content.

10. The server of claim 8 wherein the image search module matches the keywords to selected tags to establish an initial set of images, wherein the image search module filters the initial set of images in accordance with specified criteria to obtain the selected images.

11. The server of claim 10 wherein the specified criteria is selected from popularity of an image, relevance of an image to the textual content, image size, image quality and license availability.

12. The server of claim 8 wherein the visualization module supplies visualization selected from graphs, pie charts and scatter plots.

13. The server of claim 8 further comprising a harmonization module to harmonize presentation attributes.

14. The server of claim 13 wherein the presentation attributes include colors, themes, capitalization and layout.

15. The server of claim 8 further comprising an edit tool to facilitate modification of the presentation.
